(19) United States
(12) Patent Application Publication
(10) Pub. No.: US 2011/0049747 A1
(43) Pub. Date: Mar. 3, 2011

(54) Process for Bonding Metal Frame with Plastic Material

(76) Inventor: Kuo-Liang Tsai, Hsin Chuang City (TW)

(21) Appl. No.: 12/548,507

(22) Filed: Aug. 27, 2009

(51) Int. Cl. B32B 37/04

(52) U.S. Cl. 264/135

(57) ABSTRACT

A process includes preparing the metal frame that is overlaid with an adhesive. The adhesive is heated thereafter, and the adhesive becomes solidified and thus engaged securely with the metal frame. The adhesive is injection molded thereafter, and the molten resin is delivered onto the solidified adhesive to melt the adhesive so as to enable the adhesive to adhere the resin, and after the adhesive and the resin become solid, the resin forms a plastic member securely bound with the metal frame, thus forming the finished product.

### BACKGROUND OF THE INVENTION

1. Field of the Invention

The present invention relates to a process for bonding a metal frame with a plastic material and, in particular, to a process that would increase yield rate of the product formed thereby and improve manufacturing efficiency.

2. Description of the Related Art

Some laptops use metal frames for greater value and improved quality measurement, so the laptops are more attractive to customers. But, it is difficult, time-consuming and costly to fabricate any engaging members, or locking members or positioning members on the metal frame.

U.S. Pat. No. 6,893,590, entitled coupling metal parts with a plastic material, teaches a process that comprises a) applying a powder of an adhesive polymer composition to the metal surface; b) overmoulding the metal surface with a plastic material by injection moulding; c) cooling the plastic material to a temperature below its softening point; d) applying heat to the metal surface, to re-soften or re-melt the plastic material in contact with the metal surface to enhance adhesion between the plastic material and the metal surface. However, cooling and re-melting the plastic material are laborious; and re-melting the plastic material increases defect rate as to the shape and positioning of the plastic material.

Because a laptop case only has a gross profit margin 3%˜5% and any defect would incur an increase in manufacturing cost, so it is desirable to improve the prior art in order to increase yield rate for higher gross margin.

The present invention is, therefore, intended to obviate or at least alleviate the problems encountered in the prior art.

### SUMMARY OF THE INVENTION

According to the present invention, a process for bonding a metal frame with a plastic material includes preparing the metal frame that is overlaid with an adhesive. The adhesive is heated thereafter, and the adhesive becomes solidified and thus engaged securely with the metal frame. The adhesive is injection molded thereafter, and the molten resin is delivered onto the solidified adhesive to melt the adhesive so as to enable the adhesive to adhere the resin, and after the adhesive and the resin become solid, the resin forms a plastic member securely bound with the metal frame, thus forming the finished product.

It is an object of the present invention that the process improves the yield rate of the product formed thereby and increases the manufacturing efficiency.

Other objects, advantages, and new features of the present invention will become apparent from the following detailed description of the invention when considered in conjunction with the accompanied drawings

### BRIEF DESCRIPTION OF THE DRAWINGS

FIG. 1 is a flow chart of a process for bonding a metal frame with a plastic material in accordance with the present invention.

FIG. 2 is an illustrative view of a metal frame.

FIG. 3 is an illustrative view showing the metal frame overlaid with an adhesive thereafter.

FIG. 4 is an illustrative view showing the adhesive solidified and bound with the metal frame in a heating step thereafter.

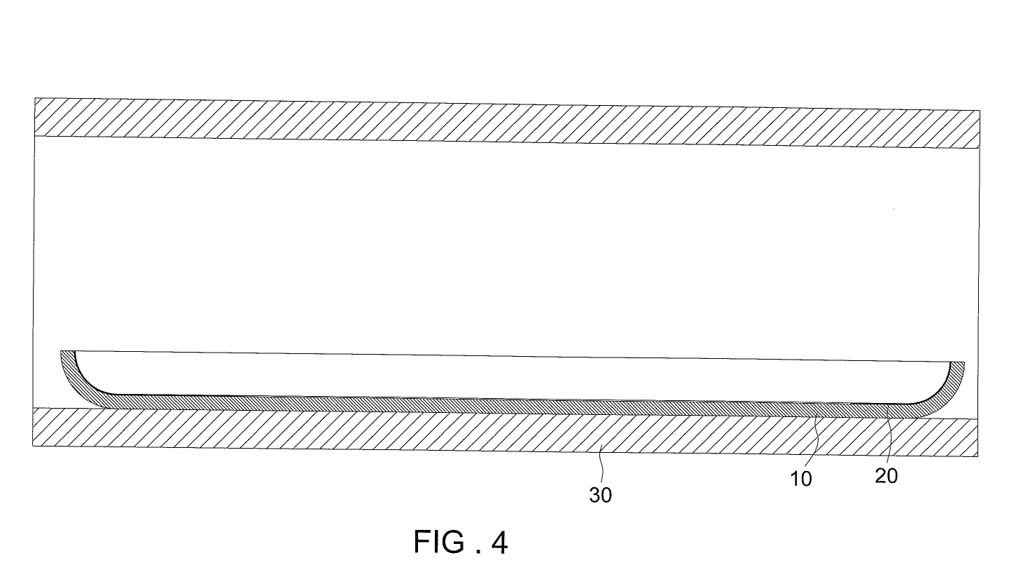

FIG. 5 is an illustrative view showing the metal frame put in a mold of an injection molding machine thereafter.

FIG. 6 is an illustrative view showing a plastic material injected on the adhesive thereafter, with the plastic material melting the contacted adhesive so as to adhere the plastic material.

FIG. 7 shows a finished product embodying the present invention ejected out of the mold.

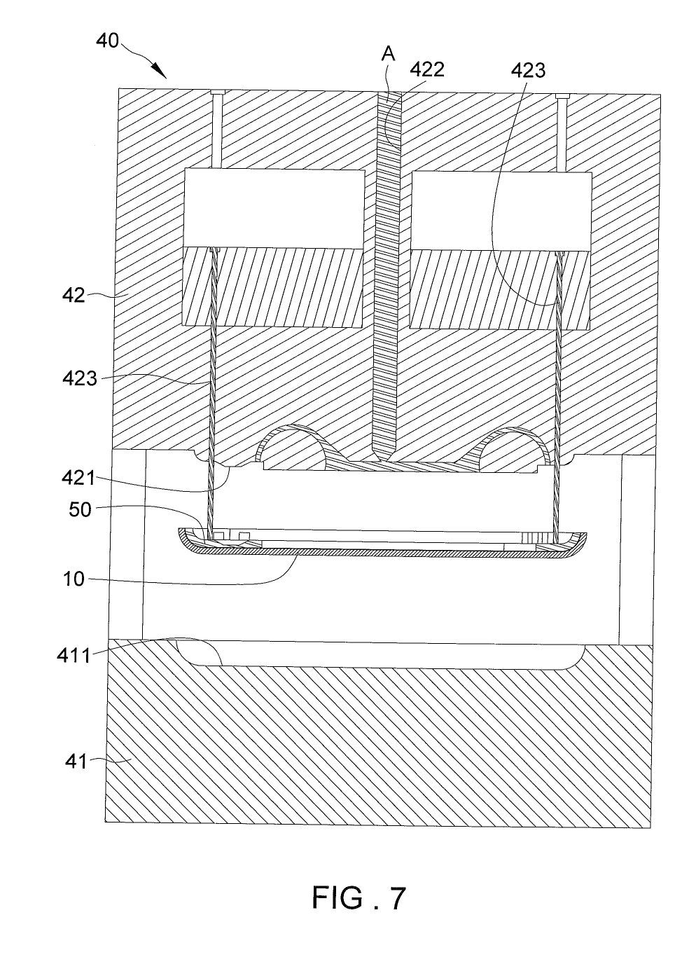

FIG. 8 is a perspective view of the finished product embodying the present invention.

FIG. 9 is a cross-section view of the finished product embodying the present invention.

### DETAILED DESCRIPTION OF THE PREFERRED EMBODIMENT

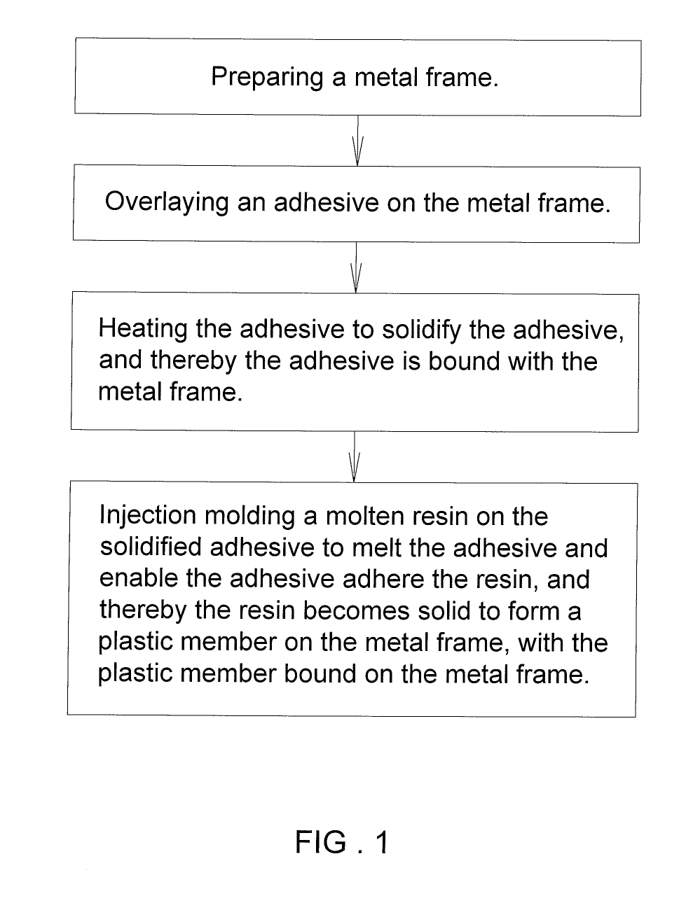

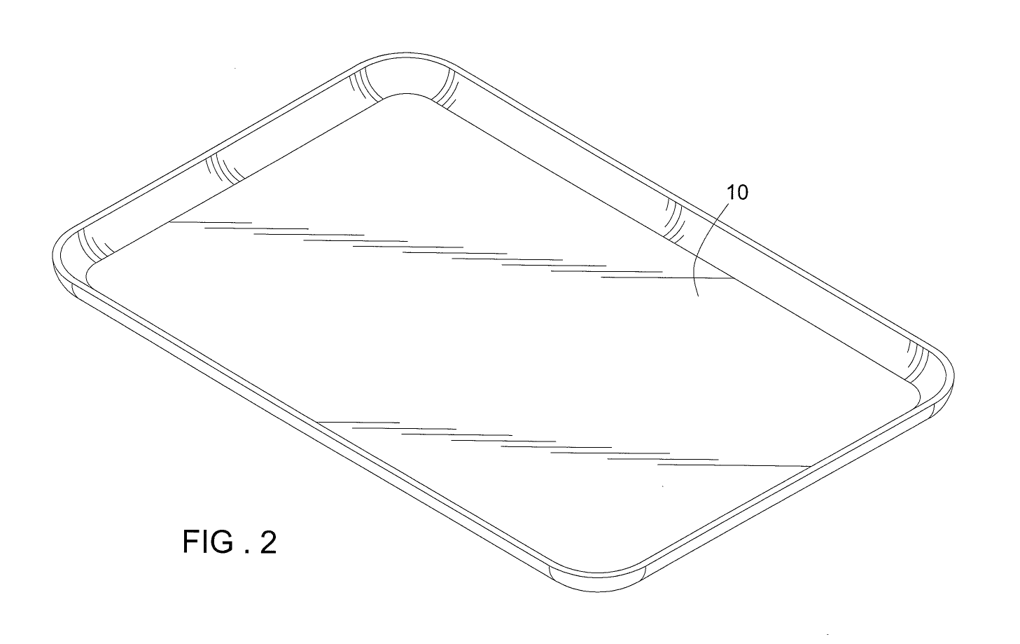

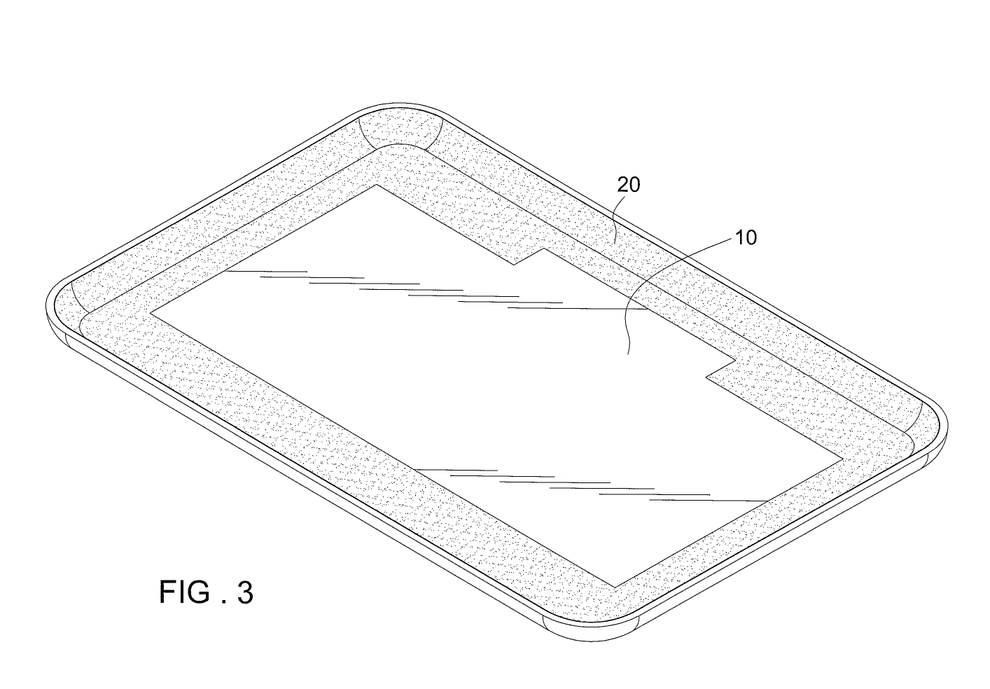

FIG. 1 shows a flow chart of a process for bonding a metal frame with a plastic material in accordance with the present invention. In this preferred embodiment, the metal frame 10 includes an inner side, an outer side opposite to the inner side, and an edge, as shown in FIGS. 2 and 3. FIGS. 2 and 3 also show the inner and outer sides are substantially flat, and the edge has an inner surface extending from the inner side and an outer surface extending from the outer side, respectively, and the edge is angled with respect to the inner and/or outer sides. Further, an adhesive 20 embodying the present invention is overlaid on one of the inner and outer sides, preferably the inner side. In this embodiment, the adhesive 20 is overlaid on the inner side and the inner surface of the edge.

The adhesive 20 used in the present invention is a PU polymer, and the adhesive 20 is mixed with diluent, methyl ethyl ketone (MEK) in this preferred embodiment, so as to allow the adhesive 20 to be easily overlaid on the metal frame 10.

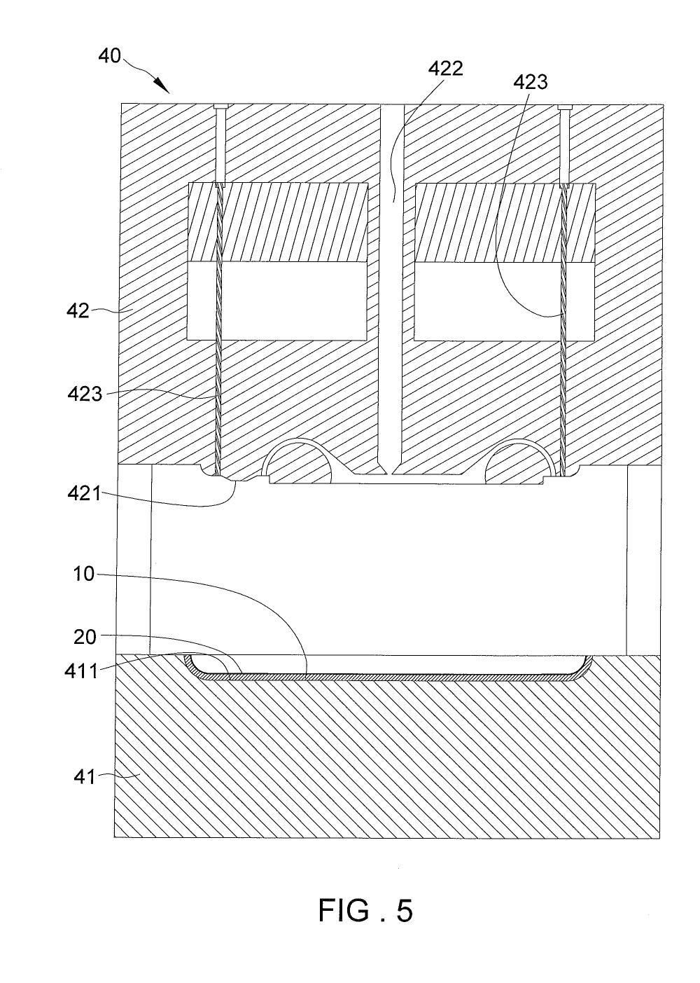

Turning to FIG. 1, the process of the present invention includes preparing the metal frame 10 and overlaying the adhesive 20 on the metal frame 10 thereafter. After the adhesive 20 is overlaid on the metal frame 10, the metal frame 10 is put in a heating device 30, as shown in FIG. 3. During the heating step, the heating device 30 is set at temperatures between 55-65 degrees centigrade, so the adhesive 20 of liquid phase is solidified and bonded securely with the metal frame 10. Further, the diluent, methyl ethyl ketone, is evaporated during the heating step. After the adhesive 20 is bound with the metal frame 10, the metal frame 10 is put in a receiving area 411 of a first mold tool 41 of an injection molding machine 40, as shown in FIG. 5. Preferably, the receiving area 411 defines a hollow, and the metal frame 10 is disposed in the hollow. The injection molding machine 40 includes a second mold tool 42 engagable with the first mold tool 41, a forming section 421 protruded from a joint face, which complemently fits and contacts with a joint face of the first mold tool 41 when the first and second mold tools 41 and 42 are engaged. The injection molding machine 40 further includes a passage 422 and an ejecting member 423 extended to the forming section 421.

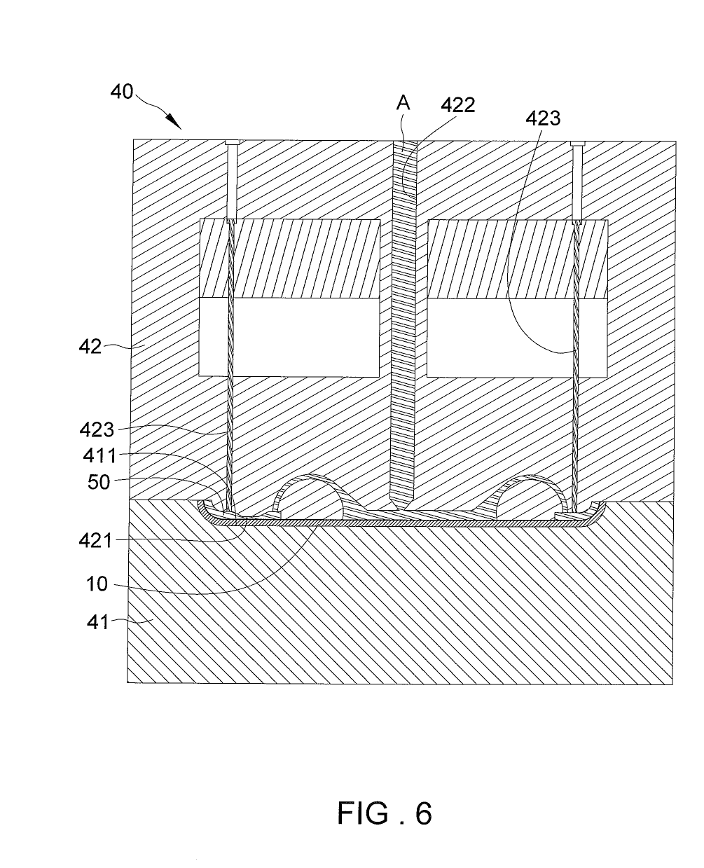

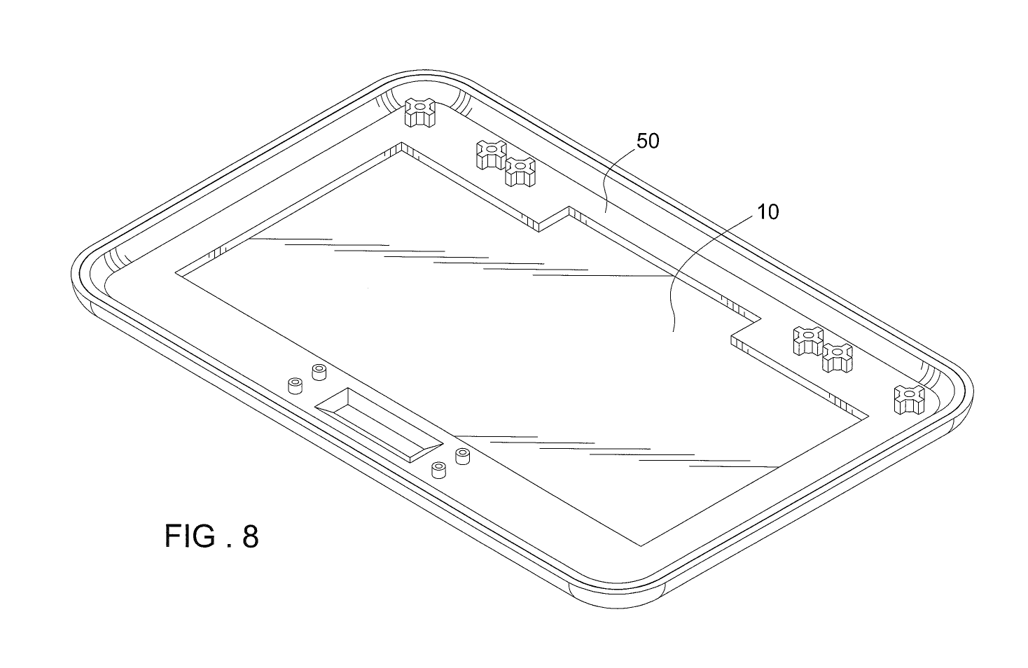

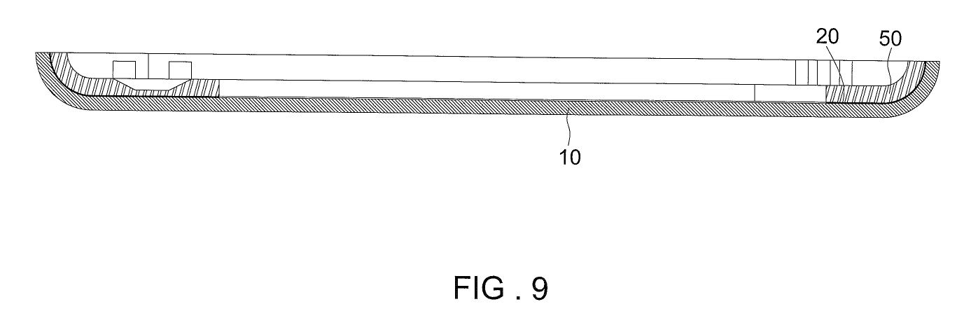

During the injection molding step (as shown in FIG. 6), the first and second mold tools 41 and 42 are engaged with each other, the passage 422 is utilized to deliver molten resin “A”. Preferably, the resin “A” is thermoplastic. Further, the forming section 421 is disposed corresponding to position of the adhesive 20, and the molten resin “A”, which has temperatures between 160-250 degrees centigrade, is delivered onto the adhesive 20 to melt the adhesive 20. When the adhesive 20 is melted, the adhesive 20 can bond with the resin “A”, and the resin “A” can form a shape corresponding to the forming section 421, and the resin “A” forms a plastic member 50 after the resin “A” is solidified. Thus, the metal frame 10 is bound with the plastic member 50 to form a finished product, as shown in FIGS. 8 and 9.

After the plastic member 50 is bound with the metal frame 10, the ejecting member 423 can extend outside the forming section 42 and grip the metal frame 10 out of the receiving area 411 of the first mold 41. Preferably, the second mold tool 42 includes two ejecting members 423. Preferably, the two ejecting members 423 may be disposed on different sides of the passage 422.

In view of the forgoing, the process in accordance with the present invention includes preparing the metal frame 10 that is overlaid with the adhesive 20. The metal frame 10 is put in the heating device 30 thereafter, and the adhesive 20 is heated to become solidified and thus engaged securely with the metal frame 10. The metal frame 10 is put in the injection molding machine 40 thereafter, and the molten resin “A” is delivered onto the solidified adhesive 20 to melt the adhesive 20 so as to enable the adhesive 20 to adhere the resin “A”, and after the adhesive 20 and the resin “A” become solid, the resin “A” forms the plastic member 50 securely bound with the metal frame 10, thus forming the finished product.

Therefore, the process of the present invention eliminates the problematic and time-consuming steps to cool and re-melt the plastic material as discussed in the “Description of the Related Art” by using the molten resin “A” to melt the adhesive 20 during the injection molding step. Thus, the yield rate of the finished product is improved and the manufacturing efficiency is increased.

Further, the diluent is used to mix with the adhesive 20 so that the adhesive 20 can be easily overlaid on the metal frame 10.

Further, the diluent is evaporated during the heating step, and the adhesive 20 changes from liquid phase to solid phase, and the solidified adhesive 20 is securely bound with the metal frame 10.

While the specific embodiments have been illustrated and described, numerous modifications come to mind without significantly departing from the spirit of invention, and the scope of invention is only limited by the scope of the accompanying claims.

What is claimed is:

1. An process for bonding a metal frame with a plastic material comprising:
preparing a metal frame;
overlaying an adhesive on the metal frame;
heating the adhesive to solidify the adhesive, and thereby the adhesive is bound with the metal frame; and
injection molding a molten resin on the solidified adhesive to melt the adhesive and enable the adhesive adhere the resin, and thereby the resin becomes solid to form a plastic member on the metal frame, with the plastic member bound on the metal frame to form a finished product.

2. The process as claimed in claim 1 wherein the adhesive is mixed with a diluent so as to enable the adhesive to be easily overlaid on the metal frame.

3. The process as claimed in claim 2 wherein the adhesive is a PU polymer and the diluent is methyl ethyl ketone.

4. The process as claimed in claim 2 wherein the diluent is evaporated when heating the adhesive to solidify the adhesive.

5. The process as claimed in claim 3 wherein the diluent is evaporated when heating the adhesive to solidify the adhesive.

6. The process as claimed in claim 1 wherein the heating temperature is set in a range of 55-65 degrees centigrade.

7. The process as claimed in claim 3 wherein the heating temperature is set in a range of 55-65 degrees centigrade.

8. The process as claimed in claim 1 wherein the molten resin has temperatures between 160-250 degrees centigrade.

9. The process as claimed in claim 2 wherein the molten resin has temperatures between 160-250 degrees centigrade.

10. The process as claimed in claim 3 wherein the molten resin has temperatures between 160-250 degrees centigrade.

11. The process as claimed in claim 6 wherein the molten resin has temperatures between 160-250 degrees centigrade.

12. The process as claimed in claim 1 wherein the resin is thermoplastic.

13. The process as claimed in claim 1 wherein the metal frame is put in an injection molding machine for injecting the molten resin on the adhesive, with the metal frame put in a first mold tool of the injection molding machine, with the injection molding machine including a second mold tool engaged with the first mold tool during injection molding, with the second mold tool including a forming section disposed corresponding to a position of the adhesive, with the molten resin forming a shape corresponding to the forming section and on the adhesive.

14. The process as claimed in claim 13 wherein the injection molding machine includes a passage utilized to deliver the molten resin on the adhesive, an ejecting member extendable out of the forming section to grips the metal frame out of the first mold tool after the plastic member is formed on the metal frame.

15. The process as claimed in claim 14 wherein the number of the ejecting member is two and the two ejecting members are disposed on different sides of the passage.

16. The process as claimed in claim 1 wherein the metal frame is put in a heating device so as to heat and solidify the adhesive.
